(19) United States
(12) Patent Application Publication
(10) Pub. No.: US 2025/0150027 A1
(43) Pub. Date: May 8, 2025

(54) POWER PLANT SYSTEM

(71) Applicant: Wolfram BAISCH, Ronneburg (DE)

(72) Inventors: Wolfram BAISCH, Ronneburg (DE); Jamhour ATEIAH, Saarbrücken (DE)

(21) Appl. No.: 18/837,876

(22) PCT Filed: Feb. 10, 2023
(86) PCT No.: PCT/EP2023/053370

§ 371 Date: Aug. 12, 2024

(30) Foreign Application Priority Data
Feb. 12, 2022 (DE) 20 2022 000 360.9

(51) Int. Cl. H02S 40/22; G02B 19/00; H02J 3/38

(52) U.S. Cl. CPC H02S 40/22; G02B 19/0009; G02B 19/0047; H02J 3/38; H02J 2300/24

(57) ABSTRACT

A power plant system comprising a number of energy converters fed by light, which are preceded on the light side by a converging lens arrangement.

### CROSS-REFERENCE TO RELATED APPLICATION

This application is a national phase of International Application No. PCT/EP2023/053370, filed Feb. 10, 2023, which is hereby incorporated by reference in its entirety.

### FIELD

This disclosure relates to a power plant system, in particular for generating electricity in a sustainable manner or using renewable energies.

### BACKGROUND

In view of the continuing increase in energy requirements under global economic and ecological criteria, as well as the need to conserve natural resources, especially in view of the current tentative decisions by industrialized nations and the demand for more consistent and faster implementation of climate targets, and the direct responsibility for unforeseeable climate change for future generations, not to mention the consequences of migration movements of entire peoples and the resulting social conflicts, sustainable, renewable power generation on an industrial scale is urgently needed.

In the recent past, energy systems have come onto the market that were and are essentially installed as functional heating conductor systems on roofs whose relative energy output is dependent on weather conditions or correspondingly quantitative solar irradiation. Such systems are generally not designed or capable of increasing or raising temperature values in such a way that significantly energetic and increased temperature setpoints can be achieved with which downstream energy converters can be operated efficiently. Depending on the time of year, for example in the winter months, snow coverings or air humidity affect objectively required maximum performance results, so that fossil fuels such as oil, gas or electricity from coal-fired power generation must be used in parallel and in addition to compensate for deficits in these systems in order to adequately supply apartments, high-rise office buildings or other demand segments with heat or electricity.

A large number of systems for generating energy and electricity are known from current technology. For example, combinations of burning glass and mirrors reveal how solar radiation can be used to produce hot water and similar energy sources. However, these and similar systems reach their upper temperature and energy limits, especially at night and depending on the weather and irradiation conditions.

On the other hand, new ferroelectric crystal systems in solar cells are supposed to achieve a temperature development that is many times higher than that of conventional solar technologies. However, this can lead to an almost excessive and, as a result, extremely surplus electricity energy that cannot be consumed or stored in the short term and must remain unused. Furthermore, questions of industrial, economic and ecological production processes remain unresolved. There are also no answers to questions about the usability/applicability of these extreme temperatures, including in the context of potential hazards. The production of components for these solar systems is also manageable in terms of sustainability and only partially climate-neutral.

In addition, there is not even a rudimentary solution to the problem of suitable storage capacities for these extremely expected and surplus energies, also with regard to extremely high investments, and there are not even rudimentary scientific technological concepts and feasibility plans. The theoretically possible achievement of (literally) 1000-fold higher temperature potentials, largely unknown multiplication production factors with regard to these suddenly and enormously available energy volumes already pose problems, also with regard to consumption time frames, simultaneous storage of energy volumes, required stand-by functional energy depots, global climate issues in the sum of new and released additional heat/temperature sources, which can also be objectively counterproductive with regard to global warming.

Constantly repeating horror scenarios of the costs incurred for the construction of energy storage facilities, in connection with the assertion of the inefficiency of the operation of such energy storage facilities, are being ignored with the decades of neglected research into the benefits of an energy source that has existed for millions of years and will certainly continue to exist for millions more, namely geothermal energy. With today's technology, it should be possible to extract existing temperatures from 100° C. to approx. 160° C. at easily accessible depths, so that it should be possible to control and extract this energy potential. In contrast, oil fields are not subject to such concerns or restrictions.

Instead of increasing or at least unchanged oil and gas extraction, with the known consequences of CO₂ emissions, it should be possible to use geothermal energy, such as geothermal heat, in a much more climate-neutral way without major problems. Fears regarding the dangers of triggering earthquakes or the like through the extraction of geothermal energy do not appear to be objectively justified. On the contrary, the extraction of geothermal energy is being ignored out of ignorance, as described above. This means that opportunities, knowledge, experience and controllability are forfeited, both in terms of space programs and the conquest of the solar system and the universe.

However, the risk of triggering earthquakes around the globe by extracting geothermal energy is probably much less detrimental than depriving humanity of its livelihoods in the long term by continuing to emit CO₂.

### SUMMARY

The aim of this disclosure is therefore to convey the above-mentioned framework conditions and perspectives with the currently prevailing conditions, to optimize costs/benefits, use and yield with regard to global warming criteria, to integrate/expand existing and externally power-limited storage potentials accordingly, and to align and make available the electricity-energy system described herein for required or necessary electricity-energy production with the collecting-lens laser device system presented herein for electricity-energy generation.

The task is to create further possibilities for energy supply, to circumvent seemingly uninfluenceable superficial dependencies of constant daylight or solar light irradiation during daylight, especially during night and/or bad weather phases, snow and/or moist coating/covering on lens and laser systems, thus ensuring and securing a sustainable and, above all, economical-ecological energy supply as seamlessly as possible.

The above-mentioned problems and requirements are solved according to this disclosure by a power plant system with a number of energy converters fed by light, which are preceded on the light side by a converging lens arrangement.

This disclosure is based on the consideration that conventional energy converters, which convert incident light directly or indirectly into electric current, could be operated with a significantly increased efficiency if the intensity of the incident light is increased. Particularly in view of the fact that high-intensity incident light, for example full sunshine, can only rarely be expected in everyday use, such a power plant system should therefore also be specifically upgraded for situations with only moderate incident light. In order to make this possible, according to one aspect of this disclosure, the energy converters are preceded by converging lens systems which concentrate the incident light even in only moderate light conditions and thus ensure a high irradiation intensity for the energy converters.

In accordance with one aspect of this disclosure, use is made, among other things, of the knowledge that even simple spectacle lenses, for example, can generate temperatures of around 350° C. at their focal point when exposed to incident sunlight. Advantageously and according to one aspect of this disclosure, the converging lenses of the converging lens system are provided with a diamond facet cut in order to further improve such a focusing effect at the focal point.

The energy converters can be any system that converts incident light directly or indirectly into electricity, for example, photocells, photovoltaic systems, photothermal systems in which a medium such as water is heated by the incident focused light and later used to generate electricity, or similar.

According to one aspect of this disclosure, a self-contained converging lens radiation system is integrated in interaction/interaction function, preferably additionally and in symbiosis with laser radiation systems or laser-active media, predominantly internally generated population inversions by virtue of stimulated light emissions or laser resonator, in order to achieve stimulated energy release/results by means of further emissions or pumping mechanisms as a result of chain reaction.

In the present light energy laser power plant according to this disclosure, it is advantageous that, for example, already in the first step of light irradiation through/in a collecting lens system consisting of special materials, certain glass ceramic structures are recommended in particular for the light energy laser power plant according to this disclosure with regard to their extremely low coefficient of thermal expansion and extremely high mechanical strength. These materials, consisting for example of glass ceramics, have already proven themselves in the past as extremely stable materials, especially under industrially extreme load processes, particularly under the influence of very high temperature resistance or long-term load phases.

In the collection lens system according to this disclosure, glass ceramics or glasses, for example, are now to be used as so-called host crystals for laser-active dopants or also semi-crystalline glass, so-called hybrids, which are characterized by both a particularly high mechanical strength and a very low coefficient of thermal expansion. These or similar glass optics materials, such as flint glass, are to be used in sizes of up to 700 mm in diameter, depending on the power requirement calculations, and positioned in quantities, numbers and sizes on corresponding carrier media in the context of other components in line with local conditions, i.e. the necessary requirements/volumes.

After sunlight/light enters/passes through converging lenses, so-called spherical or aspherical lenses, which could be plano-convex lenses, biconvex lenses, asymmetrical biconvex lenses or concave-convex lenses (meniscus) with a surface curvature suitable for the context of the present disclosure, light converges and focuses at the focal point (f). It is now advantageous that after the light enters via the collecting lens system, the converged light is focused at the focal point F and the resulting energy potentials are converted into current energies by suitable conversion systems. The electricity generated can then be used as required and fed into electricity grids as required. According to a particularly advantageous aspect of this disclosure, which is regarded as independently inventive, a number of storage elements are also connected downstream of the energy converters on the current side, in which surplus electricity can be used to generate occupation inversions. According to one aspect of this disclosure, these can in turn be used at a later time to generate laser light, which can be irradiated onto the energy converters. In this way, the irradiation on the energy converters can be supported and amplified in low-light phases, in particular when daylight is fading, so that the energy converters can operate highly efficiently even in these phases. According to one aspect of the disclosure, the surplus electricity is thus to be stored in a segmented manner in electricity/storage/battery depots (with occupancy inversions) standing in parallel in stand-by mode for this purpose until later use during phases of low irradiation during the day, bad weather or at night.

With regard to the addition of a certain number or multiplicity of spherical or aspherical collecting lens systems, with constant relatively intense solar irradiation, especially angle-adequate solar irradiation, a key function in the context in connection with integrated laser technology so-called microlens arrays, significant temperature volumes in the focal point of approximately 350° C. and beyond, higher temperature/target values can be achieved in total. An effectively suitable decomposition of the resulting beam bundles allows a homogeneous and target-guiding intensity distribution in the context.

Inside each individual collecting lens, there should be endogenously heatable, possibly transparent heating conductors directly under their surfaces in order to defrost snow and ice or to evaporate moisture deposits to ensure unhindered light irradiation. In particular, this could also be realized by providing each individual collecting lens body, for example consisting of hair-thin stainless steel ring alloys, e.g. Cr—Ni, Cr—Al or similar, or endogenously with heatable transparent heat-conducting glass mesh structures. Drainage grooves also promote unimpeded accumulation/water drainage through the infinitely variable inclined position of the collecting lens support surfaces/platforms according to the position of the sun.

The temperature values generated by focusing intensity at focal points f in the context and total sum of subsequent light wave scattering are fed into energy converters installed in the system. Already at this point of energy generation, energy dosing potentials for dynamic temperature or energy control could be used for external introduction, for example into public power grids or for internal occupation inversions, by adjusting/changing the focal length. Such a computer-aided energy distribution system has the advantage of balanced utilization of the energy shares.

In order to fulfill the above-mentioned requirement to eliminate physical obstacles, measures to restore the required power levels are advantageously implemented automatically by the system at the same time as computer-detected changes in temperature values, i.e. energy-reducing anomalies caused, for example, by cloud cover or other obstacles to irradiation. In particular, after the above criteria have been detected, an internal connection of electricity energy storage units with and for occupancy inversions can be provided for a short time, whereby the necessary electricity power contingents are called up for a limited time in order to restore a stable operating state of the energy generators.

In the event of solar irradiation failure times, i.e. energy loss anomalies detected by the computer system, such as longer periods of cloud cover, rain shower scenarios, actual unfavorable weather conditions on site, such as snowfall, fog, etc., the system automatically switches to a so-called dark mode in order to compensate for the registered lack of energy irradiation. Also and especially during and after sunset, and from measured registered twilight values, additional light systems can and are switched on by the system, which develop stimulated laser light emissions and thus contribute to further and general energy security. However, population inversions are very conducive to the generation of laser radiation, as otherwise excited electrons lose the supplied energy again through spontaneous emission.

It is therefore a significant advantage that an adequately suitable “light amplification system” is available for the large number of laser light systems for the present absorber power plant for power generation according to this disclosure. Modified solid-state lasers or modified helium-neon laser systems would be suitable for the present power plant system.

Furthermore, it is advantageous that the light-emitting laser power plant according to this disclosure has deposited, i.e. stored energy reserves or occupation inversion primarily and specifically for a system-side operating energy system, in order to seamlessly maintain the production of light-emitting energy irradiation even during temporary, unfavorable weather conditions or weakening light irradiation, thus enabling the safeguarding of public energy supply.

In addition, it is of elementary advantage to compensate for a lack of light irradiation, especially from a certain light entry limit, for example at dusk, or from the onset of constant darkness at night, to ensure so-called night-time power supply by the laser systems provided. Advantageously and in accordance with one aspect of this disclosure, these can be suitably positioned by means of a suitable positioning device so that the laser light can shine onto the energy converters. Preferably, an integrated, in particular rotatable, hydraulic telescope system is provided for this purpose. This can be activated in order to activate symbiotically closely linked laser light source systems so that any missing daylight/solar irradiation can be fully converted into so-called main laser beams via/by means of, for example, a switchable diverging lens/system in the form of decoupling light units, or via switchable alternating optics. main laser beams, i.e. point-shaped focus laser light beams through the underlying base-oriented converging lens system of the primary plane into focal points, in order to ensure the continuation of the irradiation method, i.e. energy generation for an operating activity required at night, or to replace it as far as possible.

It is also advantageous if laser light devices installed in the system are dosed and switched on with computer support at the start of dark phases at night or longer periods of heavy cloud cover. For example, the desired laser light irradiation on the converging lens systems can be controlled and called up via resistance controllers, whereby the occupancy inversion contingents are switched on as required.

Furthermore, it is advantageous if an existing laser light source system can be switched on for a night-time adapted energy supply and, depending on requirements, interchangeable laser light scattering optics similar to daylight-intensive sunlight scattering or, depending on performance-oriented effective or economically required criteria, point-shaped focus laser main beam optics are used. A preferably hydraulic positioning process of the laser light source system is automatically triggered by computer control, taking into account the current local light conditions or the prevailing weather situation, and locked in the congruent position precisely above a focusing converging lens fixture system in order to ensure a correspondingly effective and result-oriented energy yield.

It is also advantageous if the symbiosis according to this disclosure of a certain number of focusing converging lens optics, in particular with specifically aligned scattering characteristics, arranged on a so-called primary plane, with a certain number of laser light systems arranged next to or above it on a so-called secondary plane, preferably with equally specific scattering characteristics, represent in context a particularly favorable and result-oriented addition with regard to optimum energy/current generation in interaction.

A significant advantage is that at least one laser resonator per laser unit excites photons on the system side in order to trigger further emissions in a chain reaction, which are now able to generate stimulated light emissions. It is of great advantage that both self-contained systems, on the one hand the system of converging lens systems located on the primary level, and on the other hand laser system units located on the secondary level, can be positioned for fundamentally networked functionality and coexistence, requiring exact positioning points, brought about by hydraulically rotatable or telescopic mechanical robot systems.

Furthermore, it is advantageous if the fixed but movable converging lens/focal lens system of the lower level can interfere compatibly with the laser beam system, which can now be positioned exactly above it. It is therefore essential to ensure that any spontaneous chain reactions of light emissions, similar to avalanches, occur between the laser-active medium and the converging lens/focal lens system by means of extremely precise positioning in every phase of change in the position of the sun of the lower frequency source and to readjust them using laser measurement technology.

A further advantage arises from the flexibility of optical variation options designed into the system, which can be used depending on requirements and efficiency reasons with the exchange or interchangeability of the laser beam optics in that both focusing or bundled point radiation can be generated. The laser beam can be generated as focused or bundled point radiation, but can also penetrate through the underlying converging lens/focal lens system as scattered light radiation through focal lenses in order to reproduce the radiation character of sunlight adequately and as closely as possible via suitable dispersion or polarization prisms.

In addition, it is fundamentally advantageous that no external energy has to be supplied initially for the creation of laser radiation, but the required population inversion can be supplied by existing and generated internal energy from internal storage depots for the pump mechanism of the laser process. A resonator is positioned within at least one laser-active medium required by the system, which generates a large number of photons in order to produce further stimulated emissions. For example, solid-state lasers and the like could be used. For example, solid-state lasers and similar systems that operate mainly with laser-active media doped crystals or glasses could be used for the system of a current-combustion glass laser power plant according to this disclosure.

Furthermore, the laser resonator described above plays a central role in achieving the required maximum laser cavity, i.e. excitation of higher frequencies and further stimulated emissions, thus increasing the power results. When working together, the laser resonator generates identical photons, which are held in the medium by mirrors in order to significantly increase or potentiate the possibility of further stimulation.

Furthermore, it is advantageous to be able to generate electricity by means of penetration/transmission using stimulated emitting laser radiation, alternating with laser beam bundling and/or laser scattering light through optical converging lens systems, in order to feed this electricity energy into a general public power grid after the computer-detected maximum energy result and then primarily. In parallel or simultaneously, certain volumes of energy can also be fed into internal storage depots for storage in battery depots.

For the laser light systems described above as well as for the laser-active applications described above, specific focal length settings for optimum laser light generation are just as advantageous as fundamentally adequately generated wavelength stimulation of emitted light radiation intensity to generate the required occupation inversion of the required laser-side pump energy.

Finally, and of considerable importance, topographically suitable locations are an essential advantage for the focusing device-absorber-energy power plant system for electricity generation described herein, which requires uninterrupted light irradiation until total sunset. Equally essential and fundamental are topographically suitable locations that can already absorb the first morning light emissions from the sun. Sloping sites for the absorber energy power plant system according to this disclosure are particularly suitable for optimum results.

It is of significant advantage that already the first light emissions or the first spectral ranges of the visible light waves of daylight, especially through movable light-receiving areas of the construction, of the described power plant power-energy system, is computer-controlled according to each position of the sun in tilt/rotation/and hydromechanical height positioning, similar to reflecting telescopes.

Accordingly, in accordance with this disclosure, when the power plant/electricity/energy system, or the focusing collecting lens device system, is used as an absorber power plant for electricity/energy generation by means of solar irradiation, in interaction with all the above-mentioned facts for climate-neutral energy generation and at the same time general conservation of resources, thus elementary and life-sustaining sustainability.

According to this disclosure, the focusing device-absorber-energy power plant system according to this disclosure is used for generating electricity or an absorber-energy power plant system for generating electric current for feeding into public power grid systems.

In particular, this disclosure represents a thermodynamic absorber system for generating electrical energy by means of solar/daylight/light irradiation by means of focusing converging lens or dispersing lens absorber systems. In particular, this disclosure represents a thermodynamic absorber system for generating electric power energy by means of solar/daylight/light irradiation by means of focusing converging lens and/or dispersing lens absorber systems, in which active laser light irradiation is supplied periodically or in phases during periods of darkness at night, moreover during bad weather phases, by means of similarly focusing converging lens/dispersing lens systems, by means of stimulating laser light emission irradiation, supported by systemically redundant occupation inversions, in order to generate electric power energy under the premise of sustainability and climate neutrality.

### BRIEF DESCRIPTION OF THE DRAWINGS

This disclosure is explained below by way of example with reference to the figures, which show:

FIG. 1 is a perspective top view representation of a circular power plant for electricity generation according to this disclosure: primary plane 5, with collecting focal glass lens systems 21 (biconvex or plano-convex 22, or concave-convex 23) arranged thereon, endogenous system-side/cast-in heating conductors 3, against snow coating/condensation water etc.;

FIG. 2 is a perspective view of a power plant system for power generation according to this disclosure: secondary level 2, telescopic arm/mechanism 6 for laser positioning for/during the night or heavy cloud cover phases, laser beam system devices in parking position 7, axis of rotation 4, sketched on the system;

FIG. 3 is perspective side view section of the power plant system for power generation according to this disclosure: laser hardware and software 8, night-time light protection cylinder cover 9a, laser lens housing 10, focused light beams 11, focal point f 12, beam propagation characteristics after focusing through at least one focal point f 13, energy converter 14, parking housing of laser beam systems 15, housing 16;

FIG. 4 is a detailed perspective side view section of a power plant installation according to this disclosure for generating electricity: telescopic mechanism for positioning laser system units 17 and u 19, movement patterns of laser system units perpendicular or horizontal 18, suspension of laser units 20, beam characteristics/beam radius, monochromatically incoherent (LED light) 21, beam characteristics/beam radius, monochromatically coherent (23), plus additional optical components of focused laser beams 22, beam characteristics/beam radii, monochromatically coherent, by means of optical elements of beam guidance or beam shaping of focused components, respectively. Beam characteristics/beam radii, monochromatically coherent, by means of optical elements of the beam guidance or beam shaping of focused component parts, according to the description or following of propagations of self-focusing laser radiation according to Gaus 24, coherent laser propagation characteristics 25, 26, 27, energy converters 28, feeding into public power supply networks 29, population inversions 30;

FIG. 5 is a perspective view of a power plant according to this disclosure for generating electricity: angular plant/housing construction 36, solar/light radiation 31, hydraulic housing 32, motorized rotary axis device, steplessly computer-controlled according to the position of the sun, adjustable angle of inclination, horizontal/vertical/height-adjustable 33, at least one energy converter 14;

FIG. 6 is a perspective view of a power plant according to this disclosure for power generation: operating/control rooms, engine compartment 34, tilt angle mechanism 33 adequate to the position of the sun, access doors to the control center 35;

FIG. 7 is a perspective view of a power plant according to this disclosure for power generation: line-up inversions 30;

FIG. 8 is a perspective view of a power plant according to this disclosure for power generation: optionally maximum effective radiation characteristic of amplified lamp/LED light spherical (incoherent) 21, several laser light spotlights of coherent spot radiation characteristic 24, laser light spotlights of coherent radiation characteristic 22;

FIG. 9 is a perspective view of a power plant system for power generation according to this disclosure: top view of arrangement groups of relevant collecting lens systems 21, 22, 23, as well as parking containers for laser light emitters 19, computer-controlled rotatable hydraulic/telescope system 17, hydraulic protective cover 17a; and

FIG. 10 is a perspective view of a power plant according to this disclosure for power development: side view/section of convertible lens characteristics 21, 22, 23 adequate setpoint power specifications, energy converter 28, partial view of telescopic mechanics for laser beam positioning 17, symbolic representation of power grid distributor 29, occupation inversion depots 30.

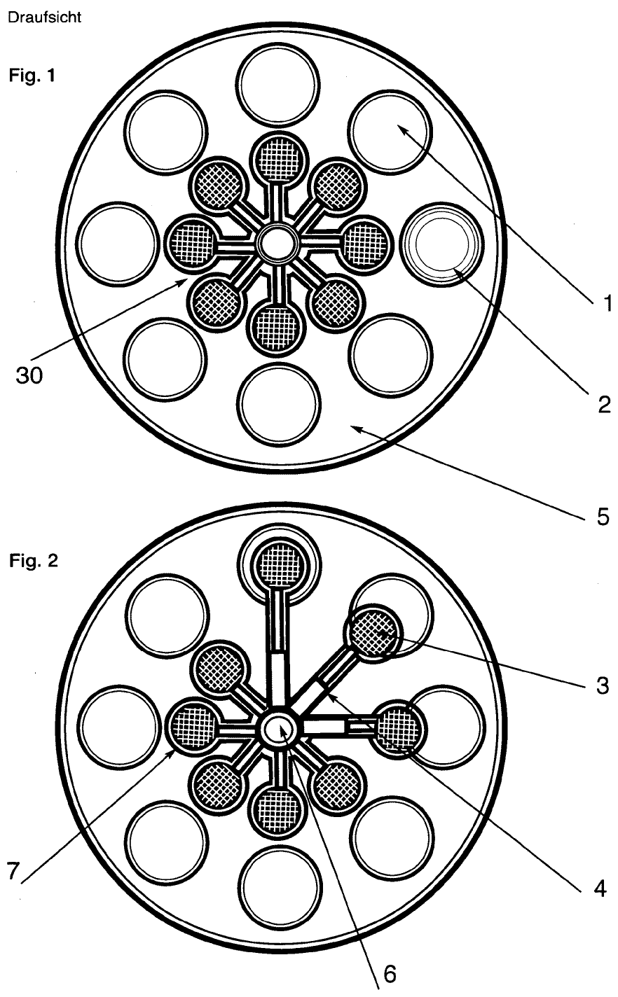

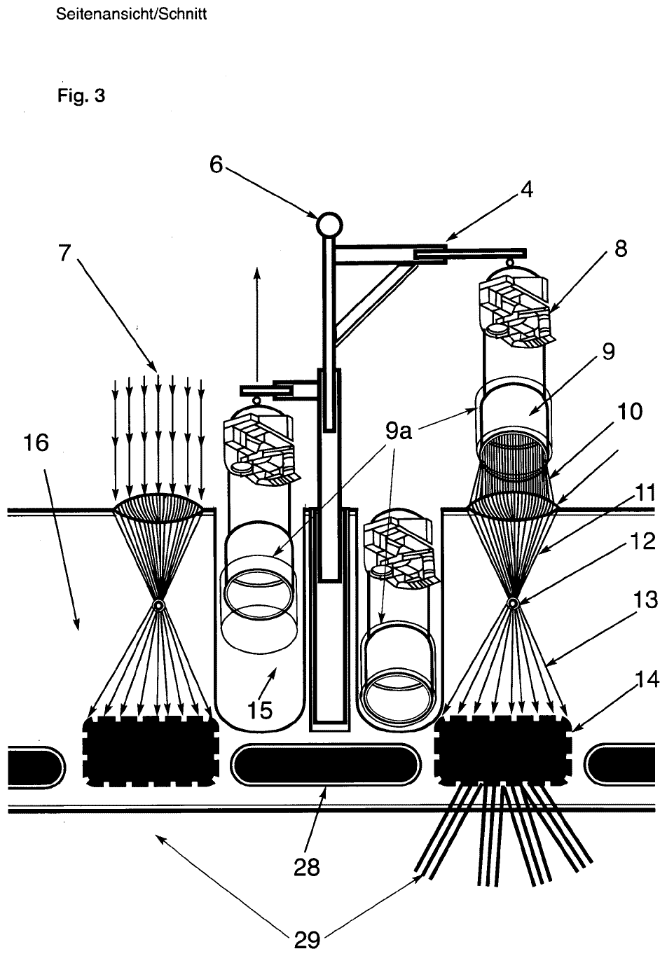

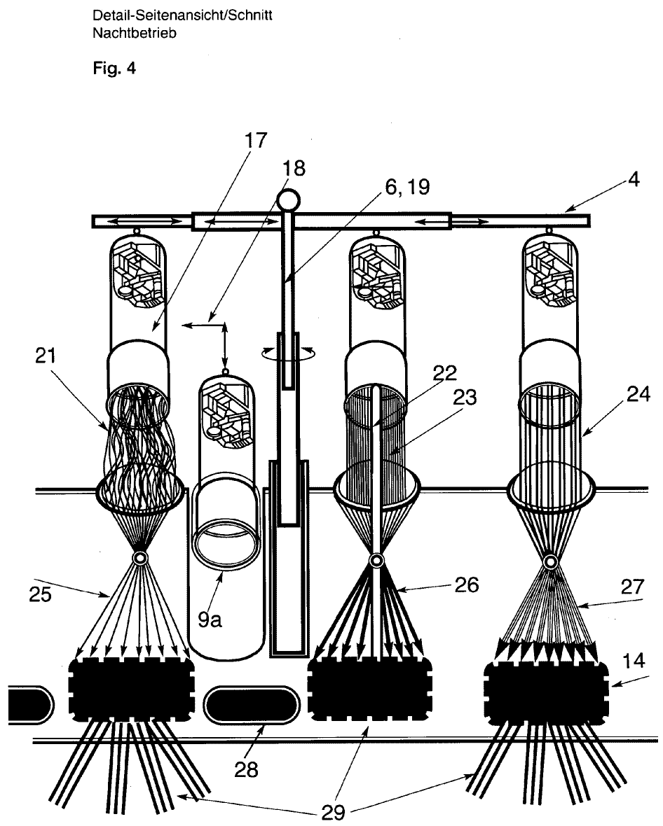

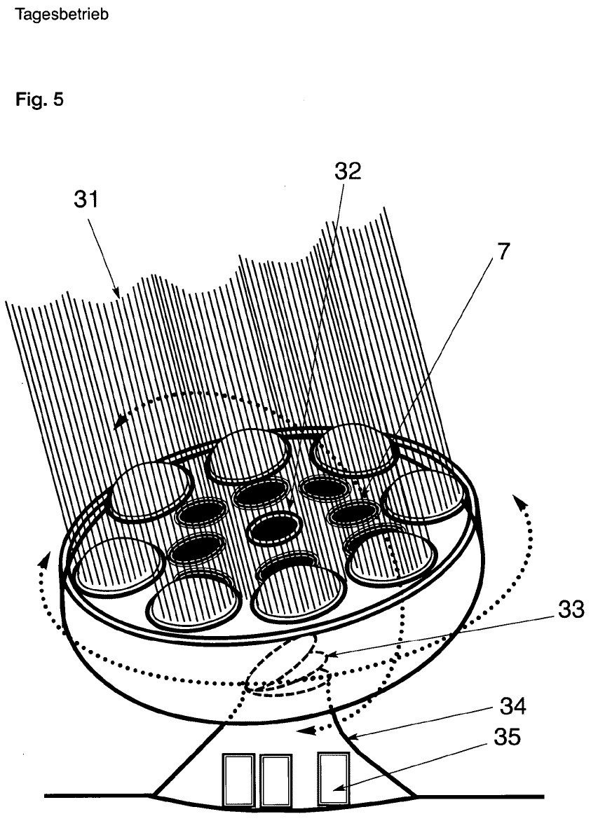

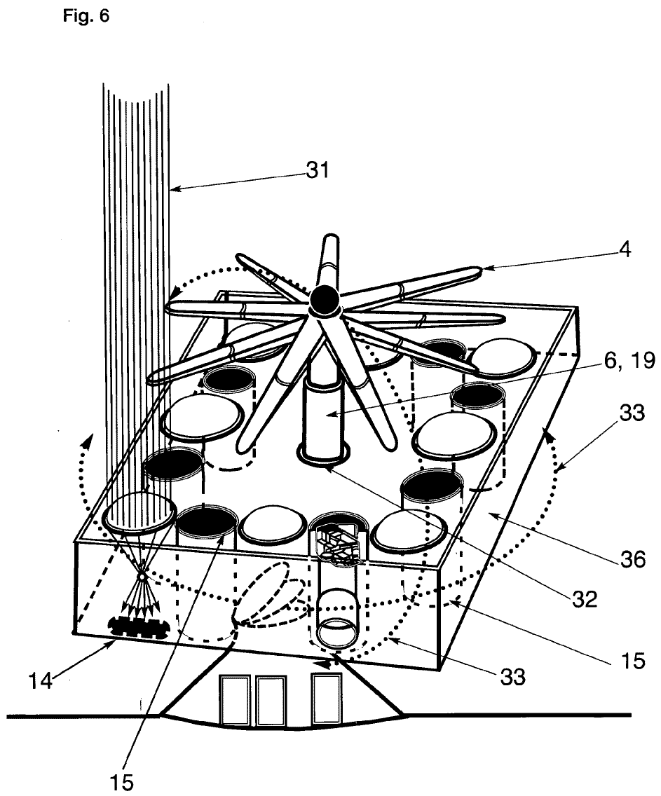

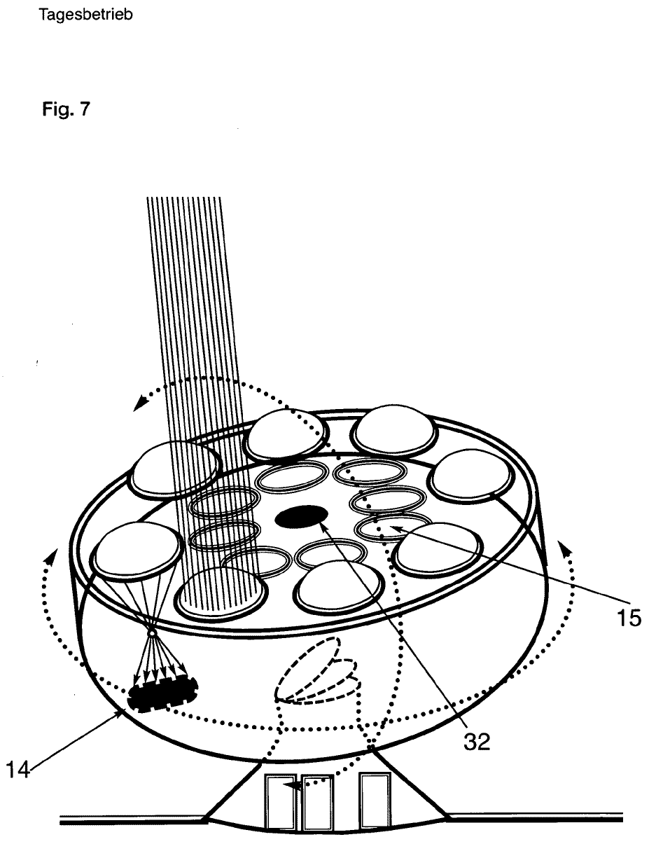

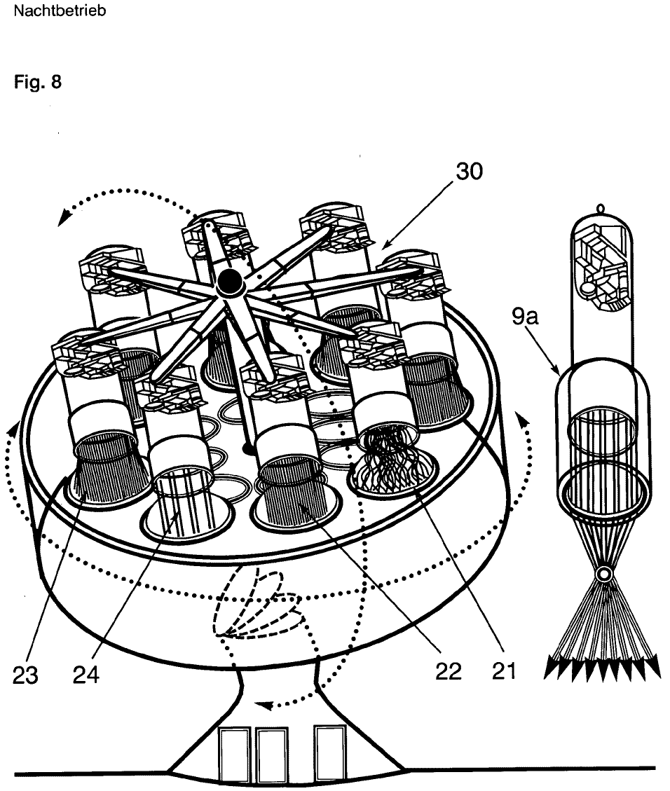

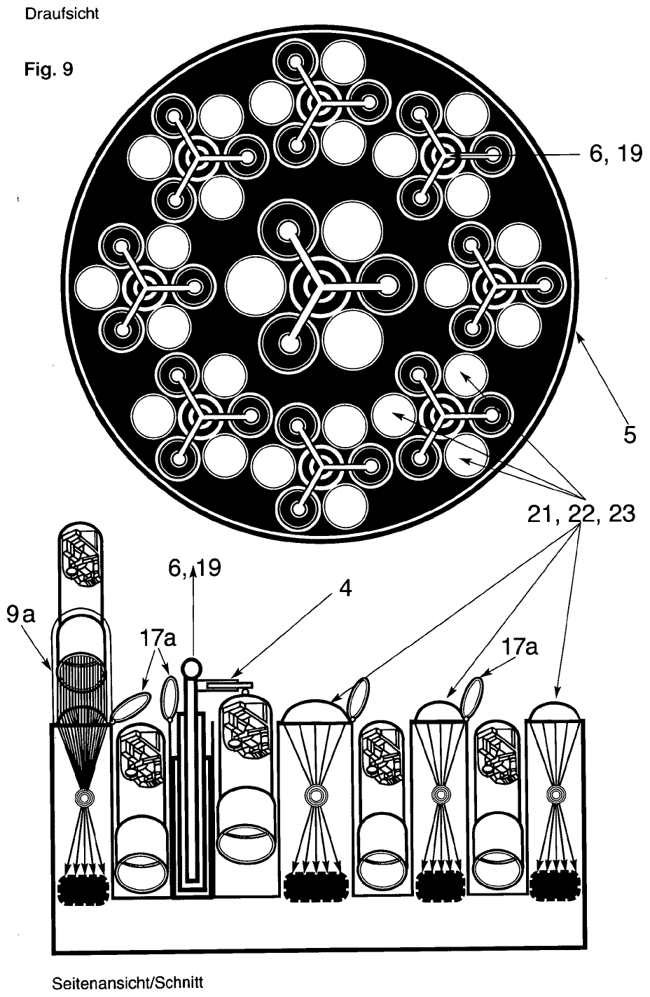

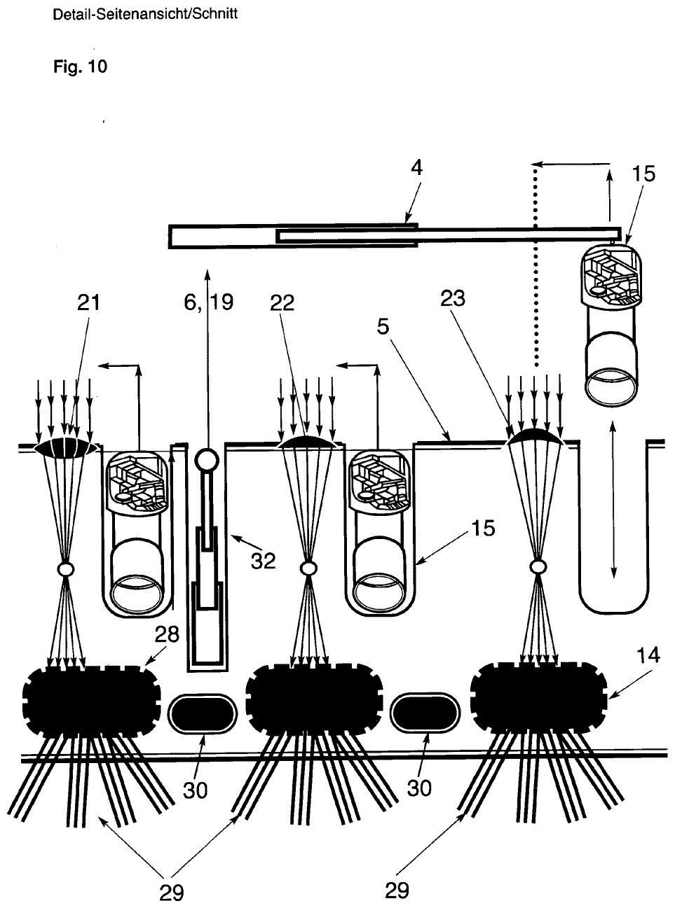

Identical parts are marked with the same reference signs in all figures.

### DETAILED DESCRIPTION

Shown is a focusing device-absorber-energy power plant system for regenerative power generation, which is sustainable and climate-neutral via focusing converging lens or dispersing lens systems, during times of day due to sunlight irradiation, moreover periodically active, and during night or darkness periods, moreover during bad weather phases, such as, for example, among others heavy cloud cover, symbiotically and in alternation/function and effect, by means of system-stimulated laser light emissions as well as relevant computer-assisted feedback loops and by virtue of redundant laser light sources, supported by systemically spent occupation inversions, to achieve required temperature setpoints, by means of at least one closed (dispersion) converging light bundles in quantities, number, sizes, arrangement and depth of effect, and through/in a multitude of resulting focal points f, by means of and use or activation of corresponding energy conversion systems, which is intended for feeding into public power grids or, alternatively, for charging the population inversions by means of computer-assisted feedback loops.

The focusing device-absorber energy power plant system for generating electricity can combine solar radiation, preferably supported by an additional interposed collector glass, solar/daylight radiation, preferably at an ideal direct radiation angle, through a collecting lens system via and through a combustion chamber/focal point f, in the center, so that already focused ray bundles are supplied to a maximum focus in the first stage of energy generation in order to achieve even higher temperature values, also and especially in the sum of the focal points.

The focusing device-absorber-energy power plant system for power generation can, in particular, bridge uncontrollable dependencies such as daylight or solar radiation in night/daytime and bad weather phases, such as snow and/or condensation, and thus ensure largely uninterrupted and trouble-free power generation.

The focusing device-absorber-energy power plant system for power generation provides a self-contained, converging total collector lens system integrated in alternating function, which in symbiosis with a multi-functional laser beam system only partially external, but predominantly internally generated population inversion, produces further emissions or pumping power as energy output results by means of stimulated light emissions or at least one laser resonator-active medium in chain reaction.

The focusing device-absorber-energy power plant system for power generation directs the solar or daylight radiation through a collecting lens system made of specially manufactured glass-ceramic structures with low thermal expansion coefficient and stable strength structure, so-called hybrids. These glass-ceramic materials have already proven themselves in the past as extremely stable materials, both straight and under extreme industrial stress processes, particularly under the influence of extremely high temperatures and long-term stress phases.

The focusing device-absorber-energy power plant system for power generation comprises glass-ceramic lenses or lens glasses or even semi-crystalline glass, so-called hybrids, as host crystals for suitable laser-active dopants. These host crystals are characterized by both a particularly high mechanical strength and extremely low thermal expansion coefficients.

The focusing device-absorber-energy power plant system for power generation comprises glass optics materials, for example also flint glasses, in sizes of preferably up to 700 mm in diameter, which could be used depending on power requirement calculations and are positioned adequately to local framework conditions, i.e. required power energy requirements/volumes in quantity, number and arrangement on corresponding carrier media yet to be described in the context of other construction components yet to be described. In particular, construction components can be alternative construction materials, e.g. lens mounts made of stainless steel, plastic or information materials such as electronic data storage media

The focusing device-absorber-energy power plant system for generating electricity comprises collecting lenses, so-called spherical or aspherical lenses, in a position after the sunlight has entered. These could be plano-convex lenses, biconvex lenses, asymmetric biconvex lenses or concave-convex lenses (meniscus) with a surface curvature suitable for the present disclosure. Therein, light converges and focuses in the focal point/focus f. After the light enters via the converging lens system, when the converged light is focused in the focal point F and the resulting energy potentials are converted into current energies by suitable conversion systems, these now converted current energies are further conducted or segmented into current networks. segmented in electricity/storage/battery depots that are capable of absorbing this energy in parallel in standby mode for low irradiation day or night phases, or forwarded to other external electricity structure networks.

The focusing device-absorber-energy power plant system for power generation comprises a combination of a certain number of spherical and/or aspherical collecting lenses, under constant or intensive mainly angle-adequate solar irradiation, ideally at 90°, which fulfill a key function in the context of integrated laser technology, so-called microlens arrays, in order to achieve significant temperature volumes in focal points/firing chambers of/above 350° C. and beyond, whereby an energetic and target-oriented decomposition/intensity distribution of beam bundles takes place.

The focusing device-absorber-energy power plant system for generating electricity comprises endogenously heatable, transparent heating conductor alloys inside individual collecting lenses, preferably directly under their surface, in order to defrost ice or snow or to evaporate moisture deposits such as condensation water. This is to be achieved in particular by using stainless steel alloys made of Cr—Ni, Cr—Al or heatable annular transparent glass rings or heat-conducting mesh structures, endogenously applied/cast in. Drainage channels/grooves should ensure that condensation water or condensation water is drained into/onto loose, movably mounted or rotatable collecting lens levels, i.e. unhindered accumulation/water drainage for laser light carrier surfaces.

The focusing device-absorber-energy power plant system for power generation is designed to ensure that the temperature values generated by/at individual focal points f on collecting lenses in total, initially separately by means of solar irradiation into/via the collecting lens-focal point system, computer-controlled at all times, are in the required and computer-controlled ideal irradiation position and pass on the temperature values obtained to predestined intensity-maximizing power conversion devices.

The focusing device-absorber-energy power plant system for power generation envisages that the electricity now generated will be fed into public power grid structures in line with demand via a collecting lens system. Excess electricity volumes, or reduced energy demand for public requirements, are to be stored in redundant electricity energy volumes in storage depots to maintain the overall operating system of the power plant and used to recharge so-called on-board battery units.

The focusing device-absorber-energy power plant system for power generation provides that, in the event of interruption of an otherwise relatively regular/evenly tolerable solar irradiation, during longer cloudy phases, system-side intolerable changes in certain temperature values, i.e. In the event of an interruption of an otherwise relatively regular/evenly tolerated solar irradiation, computer-recorded changes in certain temperature values that are intolerable for the system, i.e. energy-reduced anomalies, also with regard to external temperature framework conditions, are recorded and simultaneously switched on synchronously in the demand rhythm according to the above-mentioned criteria and, for a limited period of time, call up the necessary electricity output volumes in order to restore or guarantee a stable status quo.

The focusing device-absorber-energy power plant system for power generation is designed so that in the event of longer expected solar irradiation failures, such as rain shower scenarios, longer periods of heavy cloud cover, or scenarios in which missing or weak brightness values occur due to snowfall, fog, etc., the system automatically switches to a so-called dark mode in order to maintain the required energy output or the relevant power output level during and after sunset. For this purpose, additional laser light systems are switched on by the system from actually measurable registered or maximum twilight values, stimulated laser light emissions are developed in order to maintain the target values and contribute to further and general energy security.

The focusing device-absorber-energy power plant system for power generation takes into account that external population inversions may be required to generate laser radiation as a rule. Several available inversion sources are suitable for fulfilling this requirement. Primarily, a symbiotically coexisting, compatible, self-contained and computer-networked energy depot can fulfill this requirement. Secondarily, there is an already millions of years existing, and further millions of years existing, but still professionally not utilized occupation inversion of geothermal energy use.

The focusing device-absorber-energy-power plant system for power generation is designed so that with the computer-controlled interchangeable optics described here at the outputs of the laser sources, to the input of collimator/collecting lens systems, coherent or alternately divergent, depending on the subsequently used current converter systems to the focal point f, by the laser light amplification system, divergent radiation beams or coherent surface radiation should be possible in order to achieve particularly efficient current/energy generation with one or other of the described alternating optics at the outputs of the laser sources, after the focal point f collimator/collecting lens systems, at/by/by means of an adequate converter system.

The focusing device-absorber-energy power plant system for generating electricity preferably takes into account that a modified solid-state laser or modified helium-neon laser could be suitable for this new laser model category of a new laser light amplification system using interchangeable optics, a new laser type variant as a basis. With the multitude and variability of different laser principles for generating light emissions according to Theodore Mainman, Athur Schaw low, Albert Einstein, Charles Townes and others, the laser light amplification system energy and power plant system enriched by interchangeable optics according to this disclosure represents a further development.

The focusing device-absorber-energy power plant system for power generation is designed so that the light-energy laser power plant according to this disclosure has deposited i.e. stored energy reserves/occupation inversion primarily and specifically for a system-side operating energy system to enable the maintenance of the production of light emission and energy irradiation even during intermittent, unfavorable weather conditions or weakening light irradiation.

The focusing device-absorber-energy power plant system for power generation takes into account in one aspect that only daylight/sunlight penetrates into a dispersing lens/system, which forms a focal point in a certain number, arrangement, size-diameter, spatial radiation characteristic, initially incoherent, in the course monochromatic, in the further course of the beam after the focal point, coherent, i.e. almost with parallel propagation. The described collecting lens system is located on the system side on an irradiation primary plane that can be rotated or swiveled, hydraulically computer-controlled, depending on the position of the sun, ideally at an angle of 90° to the irradiation. If optical radiation of higher intensity is supplied, an additional significant effect can be achieved in parallel by means of self-focusing. This would allow the frequency to be doubled and the current energy to be maximized.

In one aspect, the focusing device system as an absorber power plant for power generation takes into account that, in the event of a lack of or decreasing light irradiation intensity, from a certain lower and computer-detected sun/light irradiation level, for example at dusk or after dark, a system-side superimposed, above the irradiation primary plane described under point 19. When a certain lower and computer-detected level of sunlight/light irradiation is reached, for example at dusk or when darkness has set in, a laser light source device integrated above the primary irradiation plane described under point 19 positions a rotatable and pivotable hydraulic laser irradiation secondary plane under computer control.

The focusing device system as an absorber power plant for generating electricity comprises a laser light amplifier system, coupled to at least one internal population inversion, in/through which collecting lenses arranged on the irradiation primary plane laser light radiation, possibly equipped and computer-controlled, with switchable alternating optics, which introduces coherent or incoherent beam-shaped focus laser beams, forming respective f-focal points there in order to ensure the continuation of a controlled intensive irradiation sequence by/via suitable conversion systems for operating activity required at night and to adequately replace daylight irradiation.

The focusing device system as an absorber power plant for power generation comprises an additional laser light source system on the system side for an adapted night-time energy supply, which can be switched on hydraulically and in which interchangeable polychromatic laser light scattering optics, similar to those of daylight-intensive sunlight scattered light radiation or, depending on the specifics, other effective-economically coherent focus laser main beam optics are used.

The focusing device system as an absorber power plant for power generation comprises a laser radiation secondary plane, which is automatically triggered in the context of local light/weather/conditions, and is positioned exactly above the focusing converging lens irradiation primary plane, in a congruent position, hydraulically computer-controlled, which additionally or which additionally or complementarily calls up laser light sources in a certain arrangement, quantity and depth effect intensity, positioned on the laser radiation secondary plane, during/for nocturnal darkness phases, i.e. also supplementing sensor-measured longer cloudy periods, current energy results via stored internal reference inversion deposits, activates them in a dosed manner and thus secures them.

In one aspect, the focusing device system as an absorber power plant for generating electricity provides that a certain number of laser-active optical media systems are located on the so-called secondary plane, each equipped with at least one laser resonator which excites photons, generates stimulated light emissions in order to trigger further emissions in sequence and constantly. Therefore, there is an elementary and indispensable coexistence relationship between the converging lens irradiation primary plane and the laser emission secondary plane. The primary and secondary planes contain and form a self-contained, computer and hydraulic control system with fundamental functional dependency, and enable a precisely decided positioning point of the hydraulic torsion mechanism of the moving overall system, confirmed by laser measurement, for the target-oriented effective force.

The focusing device system as an absorber power plant for power generation preferably provides for computer-controlled mechanical interchangeability of the laser output optics, laser beam characteristics from the point of view of the most efficient energy yield in terms of system flexibility, coherent radiation is generated or incoherent radiation penetrates through the primary converging lens/focal lens system located underneath as wave-dispersed light radiation through focal lenses, in order to thus adequately and as far as possible approximate solar radiation, possibly via interposed suitable dispersion lenses. to reproduce/imitate the radiation character of sunlight via suitable dispersion or polarization prisms, activate focal points and cause them to be forwarded to converter systems.

One aspect of the focusing device system as an absorber power plant for power generation is that external grid power energy should initially be supplied to create laser radiation. A population inversion required to activate pump mechanisms to produce the laser process is primarily initially available from generated internal energy from corresponding volumes, according to empirical values and calculated consumption probabilities from corresponding storage depots and their volumes.

In one aspect, the focusing device system as an absorber power plant for generating electricity provides that a resonator is positioned within the or each laser unit within a laser-active medium. Resonators are favorable for generating the appropriate quantities of photons for the absorber power plant for power generation described in this disclosure, in order to generate further stimulated emissions. For example, solid-state lasers and the like could be used for the absorber power plant for power generation according to this disclosure. Systems, mainly with laser-active media doped crystals and/or glass/hybrids, could be in operation for the absorber power plant according to this disclosure and could be used for stimulated light emissions on the system side in the current burning glass laser power plant.

In one aspect, the focusing device system as an absorber power plant for generating electricity provides for the production/generation of electricity energy by means of penetration/transmission to the respective focal points by means of stimulated emitting laser radiation through system-side alternating laser beam bundling and/or laser scattering light through optical converging lens systems, in order to maintain and achieve the maximum energy result or target values measured by computer in order to subsequently feed this electricity energy primarily into a general public power grid. In parallel or simultaneously, certain energy volumes can also be fed into internal storage depots for storage in battery depots.

The focusing device system as an absorber power plant for electricity generation takes into account in one aspect that suitable locations for interference-free light irradiation are of considerable importance. Equally essential are the advantages of certain topographical locations that enable interference-free light irradiation until total sunset. For the first morning light emissions from solar radiation, as well as the last, self-decreasing irradiation energy, hillside locations, for example, are and would be particularly suitable for optimum light/irradiation emission results.

The focusing fixture system as an absorber power plant for power generation takes into account in a further aspect that, independently and ideally of slope positions, the ability of inclination/rotation/as well as hydro-noise height positioning, similar to the known systematization of giant mirror telescopes, is to be based on optimally usable light incidence angles according to each position of the sun.

The focusing device system as an absorber power plant for power generation enables in one aspect that the power plant-power-energy system according to this disclosure, or the focusing collecting lens pre-direction system, as an absorber power plant, for power-energy generation by means of solar irradiation, in interaction, symbiosis and in connection of feedback plug loops, all the above-mentioned facts for climate-neutral energy generation, at the same time general resource conservation in the field of energy generation, achieves target values and thus documents the term sustainability.

### LIST OF REFERENCE NUMERALS

1 Lens optics heatable, converging lenses, diverging lenses e.g. flint glass or crown glass
2 Laser emitter systems or transverse laser modes
3 Top view of laser beam on telescopic arm
4 Telescopic arm mechanism for horizontal laser positioning
5 Primary carrier plane with converging lenses or diverging lenses
6 Height-adjustable hydraulic rotary axis, in conjunction with 19
7 Parking position container for laser light emitters
8 Laser hardware (electronics)
9 Laser spotlights, 9a night-time light protection cylinder/device
10 Stimulated laser light emission
11 Fused laser light radiation
12 Focal point f
13 Path length/refractive index
14 Energy converter
15 Parking position container Laser light emitter
16 Interior power plant
17 Housing laser light emitter, 17a hydraulic cover device
18 Positioning laser light emitters
19 Hydraulic telescopic mechanism for vertical position determination in conjunction with 6
20 Hydraulic telescopic mechanism for right-hand position determination in conjunction with 4
21 Sunlight ray characterization poly chromatic/incoherent/spherical (LED or)
22 Laser light-supported spotlight
23 Laser light beam characteristics monochromatic/coherent
24 Multi-supported laser spotlights
25 Radiation wavelength/focal length/refractive index from f adequate Irradiation
26 Radiation wavelength/focal length/refractive index from f adequate Irradiation
27 Radiation wavelength/focal length/refractive index from f adequate Irradiation
28 Cast inversion/s
29 Grid feed-in
30 Secondary carrier level with
31 Solar irradiation
32 Parking position telescopic/hydraulic arm mechanism
33 Power plant computer-controlled motion hydraulics adequate suns
34 Basic housing for the entire power plant
35 Access doors to the inner power plant as a whole

1. A power plant system, comprising a plurality of energy converters fed by light, which are preceded on the light side by a converging lens arrangement.

2. The power plant system according to claim 1, wherein the converging lens arrangement has a diamond facet cut.

3. The power plant system according to claim 1, wherein the energy converters are connected downstream of one or more storage elements in which population inversion can be produced.

4. The power plant system according to claim 3, wherein the storage systems are configured to generate laser light which is irradiated onto the energy converters.

5. The power plant system according to claim 1, further comprising one or more collecting lenses, each of which are provided with an integrated heating device.

6. The power plant system according to claim 1, wherein at least one of the collecting lenses is provided with a drainage run-off groove.

7. The power plant system according to claim 2, wherein the energy converters are connected downstream of one or more storage elements in which population inversion can be produced.

8. The power plant system according to claim 7, wherein the storage systems are configured to generate laser light which is irradiated onto the energy converters.

9. The power plant system according to claim 2, further comprising one or more collecting lenses, each of which are provided with an integrated heating device.

10. The power plant system according to claim 3, further comprising one or more collecting lenses, each of which are provided with an integrated heating device.

11. The power plant system according to claim 4, further comprising one or more collecting lenses, each of which are provided with an integrated heating device.

12. The power plant system according to claim 7, further comprising one or more collecting lenses, each of which are provided with an integrated heating device.

13. The power plant system according to claim 8, further comprising one or more collecting lenses, each of which are provided with an integrated heating device.

14. The power plant system according to claim 2, wherein at least one of the collecting lenses is provided with a drainage run-off groove.

15. The power plant system according to claim 3, wherein at least one of the collecting lenses is provided with a drainage run-off groove.

16. The power plant system according to claim 4, wherein at least one of the collecting lenses is provided with a drainage run-off groove.

17. The power plant system according to claim 5, wherein at least one of the collecting lenses is provided with a drainage run-off groove.

18. The power plant system according to claim 7, wherein at least one of the collecting lenses is provided with a drainage run-off groove.

19. The power plant system according to claim 8, wherein at least one of the collecting lenses is provided with a drainage run-off groove.

20. The power plant system according to claim 9, wherein at least one of the collecting lenses is provided with a drainage run-off groove.
